(19) United States
(12) Patent Application Publication
(10) Pub. No.: US 2007/0183793 A1
(43) Pub. Date: Aug. 9, 2007

(54) Device and method for detecting received optical power in optical communication network

(75) Inventors: Jun Zhao, Shenzhen (CN); Yuntao Wang, Shenzhen (CN); Wei Huang, Shenzhen (CN); Jun Chen, Shenzhen (CN); Tao Jiang, Shenzhen (CN); Peilong Tan, Shenzhen (CN); Feng Wang, Shenzhen (CN); Huafeng Lin, Shenzhen (CN); Guo Wei, Shenzhen (CN)

Correspondence Address: WOLF GREENFIELD & SACKS, P.C., 600 ATLANTIC AVENUE, BOSTON, MA, 02210-2206, US

(73) Assignee: Huawei Technologies Co., Ltd., Shenzhen (CN)

(21) Appl. No.: 11/595,841

(22) Filed: Nov. 9, 2006

(30) Foreign Application Priority Data
Feb. 9, 2006 (CN) CN 200610003540.0

(51) Int. Cl. H04B 10/06

(52) U.S. Cl. 398/212

(57) ABSTRACT

A device and a method for detecting received optical power in an optical communication network, the device mainly including: an optical splitter for separating a part from an uplink optical signal received by an optical receiver in the optical communication network and transferring the part of optical signal to a photoelectric converter; the photoelectric converter for converting the received optical signal transferred from the optical splitter into a current or voltage signal and transferring the current or voltage signal to a logic control circuit; and the logic control circuit for judging the received current or voltage signal transferred from the photoelectric converter according to a set threshold to determine whether the received optical power of the optical receiver in the optical communication network overloads, and for outputting a corresponding control signal.

### FIELD OF THE INVENTION

The present invention relates to the field of optical communication network, and more particularly to a device and a method for detecting the received optical power in an optical communication network.

### BACKGROUND OF THE INVENTION

A fiber point-to-multipoint optical access network includes a central office terminal, that is, Optical Line Terminal (OLT), a Splitter (passive optical splitter), a plurality of remote Optical Network Terminals (ONTs) or Optical Network Units (ONUs) and a plurality of fibers. The OLT is connected to the Splitter via a fiber which is a trunk fiber of the optical network. The Splitter is connected to the plurality of remote ONTs or ONUs respectively via a plurality of branch fibers. To avoid the ambiguity, the ONUs and the ONTs are hereinafter collectively referred to as ONTs hereinafter.

A schematic diagram illuminating the typical network topology of a Passive Optical Network (PON) is shown in FIG. 1. In the PON, the uplink data flows are transferred between the OLT and the remote ONTs through traffic scheduling of each remote ONT implemented by the OLT. The OLT authorizes each ONT according to the bandwidth request of each ONT by allocating authorization information of the uplink transmission data flows for each ONT; the authorization information includes the bandwidth information of each ONT; and the OLT implements the uplink transmission traffic scheduling on the ONTs by means of the authorization information.

A schematic diagram illuminating the basic structure of the optical receiver in the OLT and each of the ONTs in the PON is shown in FIG. 2.

Response signal saturation will occur when a photoelectric device in the optical receiver is exposed under a strong light, and thus damage will occur on the photoelectric device. After the response signal saturation occurs in the photoelectric device, the photoelectric device is unable to detect the variation of the signal light, and the signal light response function may not be recovered in a long period, so a saturation threshold of the photoelectric device is an important parameter for some applications. In practical applications, the photoelectric device may be irradiated from the front and the back with a laser, so as to determine whether the photoelectric device is damaged according to the amplitude variation in the response of the photoelectric device to the signal light.

### SUMMARY OF THE INVENTION

The embodiments of the present invention provide a device and a method for detecting received optical power in an optical communication network.

The object of the present invention is achieved though the following technical schemes:

The device for detecting received optical power in an optical communication network, the device including:

an optical splitter for separating a part from an uplink optical signal received by an optical receiver in the optical communication network and transferring the part of optical signal to a photoelectric converter;

the photoelectric converter for converting the received part of optical signal transferred from the optical splitter into a current or voltage signal and transferring the current or voltage signal to a logic control circuit; and

the logic control circuit for judging the received current or voltage signal transferred from the photoelectric converter according to a set threshold to determine whether the received optical power of the optical receiver in the optical communication network overloads, and for outputting a corresponding control signal.

The device further includes:

a protocol chip for recording the uplink time slot of the uplink optical signal corresponding to the current or voltage signal received by the logic control circuit, and for comparing the recorded uplink time slot with the uplink time slot allocated by a central office terminal for each Optical Network Terminal (ONT) or Optical Network Unit (ONU).

The logic control circuit includes:

an overload threshold setting module for setting the threshold of the current or voltage signal, wherein the threshold is used for determining whether the received optical power of the optical receiver in the optical communication network overloads; and

an overload determining module, when the current or voltage signal transferred from the photoelectric converter is larger than the threshold set in the overload threshold setting module, the overload determining module making a determination that the received optical power of the optical receiver in the optical communication network overloads, and outputting the corresponding control signal.

The protocol chip includes:

an overload recording module for recording the uplink time slot of the uplink optical signal corresponding to the current or voltage signal, which leads to the received optical power overload of the optical receiver in the optical communication network, received by the logic control circuit; and

an overload locating module for comparing the uplink time slot recorded by the overload recording module with the uplink time slot allocated by the central office terminal for each Optical Network Terminal or Optical Network Unit, so as to determine which ONT or OUN transmits the uplink optical signal that leads to the received optical power overload of the optical receiver.

Optionally, the logic control circuit includes:

an optical receiver damage threshold setting module for setting a threshold of the current or voltage signal, wherein the threshold is used for determining whether the optical receiving module of the optical receiver in the optical communication network may be damaged;

an optical receiver damage determining module, when the current or voltage signal transferred from the photoelectric converter is larger than the threshold set in the optical receiver damage threshold setting module, the optical receiver damage determining module outputting the corresponding control signal.

The device further including:

an optical switch for turning off the optical path leading to the optical receiver in the optical communication network according to the control signal outputted by the optical receiver damage determining module, so as to make the optical receiver unable to receive the uplink signal.

The protocol chip includes:

an optical receiver damage recording module for recording the uplink time slot of the uplink optical signal corresponding to the current or voltage signal, which may damage the optical receiving module of the optical receiver, received by the logic control circuit; and

an optical receiver damage locating module for comparing the uplink time slot recorded by the optical receiver damage recording module with the uplink time slot allocated by the central office terminal for each remote ONT or ONU, so as to determine which ONT or ONU transmits the uplink optical signal that may damage the optical receiver.

A method for detecting the received optical power in the optical communication network including the steps of:

A. separating a part from an uplink optical signal received by an optical receiver in the optical communication network and converting the part of optical signal into a current or voltage signal; and

B. judging the current or voltage signal according to a set threshold to determine whether the received optical power of the optical receiver overloads.

The Step A includes:

connecting an optical splitter with an uplink optical signal receiving fiber of the optical receiver in the optical communication network, separating by the optical splitter a set proportion of optical signal from the uplink optical signal received by the optical receiver, and converting the separated optical signal into a current or voltage signal by a photoelectric converter.

The Step B includes:

B1. setting the threshold of the current or voltage signal, wherein the threshold is used for determining whether the received optical power of the optical receiver overloads; and

B2. when the current or voltage signal is larger than the set threshold, determining the received optical power of the optical receiver in the optical communication network overloads and outputting a corresponding control signal.

The Step B2 includes:

B21. recording the uplink time slot of the uplink optical signal corresponding to the current or voltage signal that leads to the received optical power overload of the optical receiver; and

B22. comparing the uplink time slot with the uplink time slot allocated by the central office terminal for each ONT or ONU to determine which ONT or ONU transmits the uplink signal that leads to the received optical power overload of the optical receiver.

The Step B further includes:

B3. setting the threshold of the current or voltage signal, wherein the threshold is used for determining whether an optical receiving module of the optical receiver in the optical communication network may be damaged; and

B4. when the current or voltage signal is larger than the set threshold, outputting a corresponding control signal.

The Step B4 includes:

arranging an optical switch in the optical communication network, the optical switch turning off the optical path leading to the optical receiver in the optical communication network upon receiving the outputted control signal so as to make the optical receiver unable to receive the uplink optical signal.

The Step B4 further includes:

B41. recording the uplink slot of the uplink optical signal corresponding to the current or voltage signal that may damage the optical receiving module of the optical receiver;

B42. comparing the uplink time slot with the time slot allocated by a central office terminal for each ONT or ONU to determine which ONT or ONU transmits the uplink optical signal that may damage the optical receiving module of the optical receiver.

The optical communication network includes a Passive Optical Network (PON).

It can be seen from the technical solution provided by the present invention, the embodiments of the present invention may detect the received optical power overload in the optical receiver in the PON rapidly by providing photoelectric conversion device and logic control device, determine whether the overloaded received optical power will damage the optical receiving module of the optical receiver, and then adopt corresponding a measure to protect the optical receiver. The embodiments of the present invention may also rapidly locate in the PON the ONT in which a fault occurs and which transmits the high-power uplink signal.

### BRIEF DESCRIPTION OF THE DRAWINGS

FIG. 1 is a schematic diagram illuminating a typical network topology of a PON;

FIG. 2 is a schematic diagram illuminating the basic structure of the optical receiver in the OLT and each of the ONTs in the PON;

FIG. 3 is a schematic diagram illuminating the structure of the device in the PON according to an embodiment of the present invention;

FIG. 4 is a schematic diagram illuminating the structure of the device in the PON according to an embodiment of the present invention;

FIG. 5 is a schematic diagram illuminating the correspondence relationship between the optical power detecting time table and the uplink time slot table allocated by the OLT for each ONT according to an embodiment of the present invention;

FIG. 6 is a processing flow chart of the method according to an embodiment of the present invention.

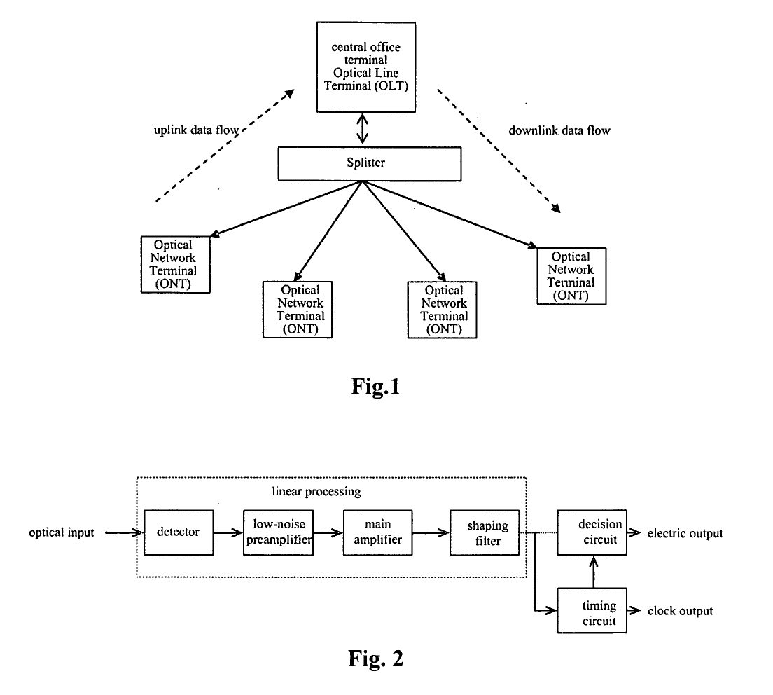

### DETAILED DESCRIPTION OF THE PREFERRED EMBODIMENTS

The embodiments of the present invention provide a device and a method for detecting the received optical power in the optical communication network. The key of the embodiments of present invention is: connecting a photoelectric conversion device and a logic control device to the uplink optical signal receiving fiber of the optical receiver in the PON, detecting the power of the uplink optical signal received by the PON, and determining whether the received optical power overloads.

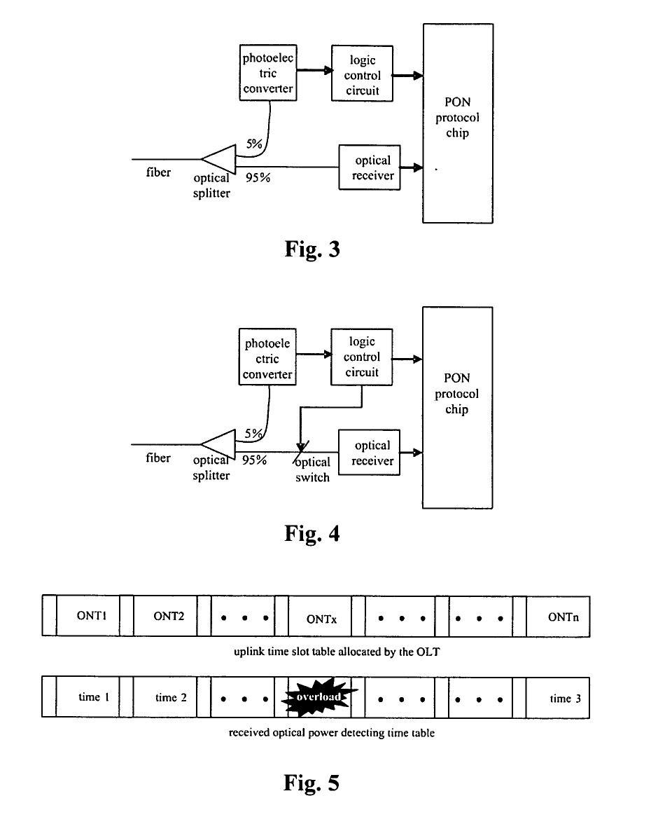

The embodiments of the present invention will be described in detail hereinafter with reference to the accompanying drawings. The structure of the device in the PON according to an embodiment of the present invention is shown in FIG. 3, including the following modules:

an optical splitter: which is configured to connect with the uplink optical signal receiving fiber of the optical receiver in the PON, split the power of the uplink optical signal received by the PON, and separate, for example, but not limited to, about 5% of the optical signal from the uplink optical signal to transfer to a photoelectric converter.

the photoelectric converter: which is configured to convert the optical signal transferred from the optical splitter to a current or voltage signal, and transfer the current or voltage signal to a logic control circuit.

the logic control circuit: which is configured to judge the current or voltage signal transferred from the photoelectric converter according to a set threshold I₀; when the current or voltage signal transferred from the photoelectric converter exceeds the set threshold I₀, the logic control circuit makes a determination that the optical power received by the PON overloads, and outputs a control signal to the PON protocol chip. The logic control circuit is also configured to transfer the current or voltage transferred from the photoelectric converter to the PON protocol chip.

To protect the optical receiver in the PON in the case of intended high-power uplink optical signal, an optical switch may also be added to the structure shown in FIG. 3. The structure of the device in the PON according to another embodiment of the present invention is shown in FIG. 4.

The optical splitter and the photoelectric converter in the structure shown in FIG. 4 have functions respectively the same as those of the optical splitter and the photoelectric converter in the structure shown in FIG. 3.

In the structure shown in FIG. 4, the logic control circuit is configured to judge the received current or voltage signal transferred from the photoelectric converter according to two set thresholds I₀ and I₁. When the current or voltage transferred from the photoelectric converter exceeds the set threshold I₀, the logic control circuit makes a determination that the optical power received by the PON overloads but will not damage the optical receiving module of the optical receiver, and then outputs a control signal to the PON protocol chip; and when the current or voltage transferred from the photoelectric converter exceeds the set threshold I₁, the logic control circuit makes a determination that the optical power received by the PON is too high and may damage the optical receiving module of the optical receiver, and then outputs a control signal to the optical switch. The logic control circuit also transfers the current or voltage transferred from the photoelectric converter to the PON protocol chip.

The optical switch is configured to connect with the uplink optical signal receiving fiber of the optical receiver in the PON; upon receiving the control signal transferred from the logic control circuit, the optical switch is turned off rapidly to close the optical path leading to the optical receiver, such that the optical receiver of the PON is unable to receive the uplink optical signal and thus may be protected.

The uplink optical signal in the PON is transmitted by using Time Division Multiple Access (TDMA), and each of the ONTs is allocated by the OLT with an uplink time slot different from those of others to avoid conflict.

Therefore, the PON protocol chips in the structure shown in FIG. 3 and FIG. 4 are configured to record the current or voltage signal transferred from the photoelectric converter and the uplink time slot of the uplink optical signal corresponding to the current or voltage signal into an optical power detecting time table. The correspondence relationship between the optical power detecting time table and the uplink time slot table which is allocated by the OLT for each ONT is shown in FIG. 5.

As shown in FIG. 5, by comparing the optical power detecting time table and the uplink time slot table which is allocated by the OLT for each ONT, it may be determined which ONT is in fault and transmits the high-power uplink signal.

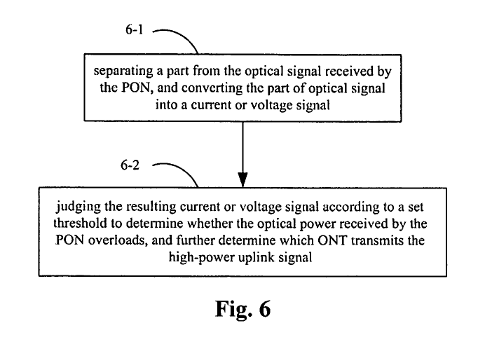

The processing flow of the method according to the embodiment of the present invention is shown in FIG. 6, which includes the steps of:

Step 6-1: separating a part from the uplink optical signal received by the PON, and converting the part of the optical signal into a current or voltage signal.

Specifically, the uplink optical signal received by the PON is detected, and a part is separated from the uplink optical signal. For example, the optical splitter may connect with the uplink optical signal receiving fiber of the optical receiver in the PON, and separate about 5% of the optical signal from the uplink optical signal.

Then the separated optical signal is converted into a current or voltage signal. The conversion process may be carried out by the photoelectric converter.

Step 6-2: judging the current or voltage signal according to a set threshold to determine whether the received optical power by the PON overloads, and further determining which ONT transmits the high-power uplink signal.

After the separated optical signal is converted into the current or voltage signal, a judgment is implemented on the current or voltage signal according to a set threshold.

Specifically, two thresholds I₀ and I₁ are set at first; when the current or voltage signal is larger than I₀, it is determined that the optical power received by the PON overloads but will not damage the optical receiving module of the optical receiver, and then a control signal is output to the PON protocol chip. The PON chip also records the uplink time slot of the uplink optical signal corresponding to the current or voltage signal that leads to the received optical power overload (i.e., larger than I₀).

When the current or voltage signal is larger than I₁, it is determined that the optical power received by the PON is too high and may damage the optical receiving module of the optical receiver; therefore it needs some measures to protect the optical receiver of the PON. For example, the optical path leading to the optical receiver may be closed by the optical switch such that the optical receiver of the PON can not receive the uplink optical signal, so as to protect the optical receiver of the PON. The PON protocol chip also records the uplink time slot of the uplink optical signal corresponding to the current or voltage signal which may damage the optical receiver (i.e., larger than I₁).

By comparing the recorded uplink time slot of the uplink optical signal corresponding to the current or voltage signal that leads to the received optical power overload, the recorded uplink time slot of the uplink optical signal corresponding to the current or voltage signal which may damage the optical receiver with the uplink time slot allocated by the OLT to each OTNs, it may be determined which ONT is in fault and transmits the high-power uplink signal that leads to the received optical power overload or may damage the optical receiver.

Though the present invention is described above in preferred embodiments, it is noted that those skilled in the art may make modifications and variations, without departing from the basic principle of the present invention; any of those modifications and variations shall fall into the protected scope of the present invention defined by the accompanied claims.

What is claimed is:

1. A device for detecting received optical power in an optical communication network, comprising:
an optical splitter for separating a part from an uplink optical signal received by an optical receiver in the optical communication network and transferring the part of optical signal to a photoelectric converter;
the photoelectric converter for converting the received part of optical signal transferred from the optical splitter into a current or voltage signal and transferring the current or voltage signal to a logic control circuit; and
the logic control circuit for judging the received current or voltage signal transferred from the photoelectric converter according to a set threshold to determine whether the received optical power of the optical receiver in the optical communication network overloads, and for outputting a corresponding control signal.

2. The device of claim 1 further comprising:
a protocol chip for recording the uplink time slot of the uplink optical signal corresponding to the current or voltage signal received by the logic control circuit, and for comparing the recorded uplink time slot with the uplink time slots allocated by a central office terminal respectively for each Optical Network Terminal (ONT) or Optical Network Unit (ONU).

3. The device of claim 2, wherein said logic control circuit comprises:
an overload threshold setting module for setting the threshold of the current or voltage signal, wherein said threshold is used for determining whether the received optical power of the optical receiver in the optical communication network overloads; and
an overload determining module, when the current or voltage signal transferred from the photoelectric converter is larger than the threshold set in the overload threshold setting module, said overload determining module making a determination that the received optical power of the optical receiver in the optical communication network overloads, and outputting the corresponding control signal.

4. The device of claim 3, wherein said protocol chip comprises:
an overload recording module for recording the uplink time slot of the uplink optical signal corresponding to the current or voltage signal, which leads to the received optical power overload of the optical receiver in the optical communication network, received by the logic control circuit; and
an overload locating module for comparing the uplink time slot recorded by the overload recording module with the uplink time slot allocated by the central office terminal for each Optical Network Terminal or Optical Network Unit, so as to determine which ONT or OUN transmits the uplink optical signal that leads to the received optical power overload of the optical receiver.

5. The device of claim 2, wherein said logic control circuit comprises:
an optical receiver damage threshold setting module for setting a threshold of the current or voltage signal, wherein said threshold is used for determining whether the optical receiving module of the optical receiver in the optical communication network may be damaged;
an optical receiver damage determining module, when the current or voltage signal transferred from the photoelectric converter is larger than the threshold set in the optical receiver damage threshold setting module, said optical receiver damage determining module outputting the corresponding control signal.

6. The device of claim 5 further comprising:
an optical switch for turning off the optical path leading to the optical receiver in the optical communication network according to the control signal outputted by the optical receiver damage determining module, so as to make the optical receiver unable to receive the uplink signal.

7. The device of claim 5, wherein said protocol chip comprises:
an optical receiver damage recording module for recording the uplink time slot of the uplink optical signal corresponding to the current or voltage signal, which may damage the optical receiving module of the optical receiver, received by the logic control circuit; and
an optical receiver damage locating module for comparing the uplink time slot recorded by the optical receiver damage recording module with the uplink time slot allocated by the central office terminal for each remote ONT or ONU, so as to determine which ONT or ONU transmits the uplink optical signal that may damage the optical receiver.

8. A method for detecting received optical power in an optical communication network, comprising the steps of:
A. separating a part from an uplink optical signal received by an optical receiver in the optical communication network and converting the part of optical signal into a current or voltage signal; and
B. judging the current or voltage signal according to a set threshold to determine whether the received optical power of the optical receiver overloads.

9. The method of claim 8, wherein said Step A comprises:
connecting an optical splitter with an uplink optical signal receiving fiber of the optical receiver in the optical communication network, separating by the optical splitter a set proportion of optical signal from the uplink optical signal received by the optical receiver, and converting the separated optical signal into a current or voltage signal by a photoelectric converter.

10. The method of claim 8, wherein said Step B comprises:
B1. setting the threshold of the current or voltage signal, wherein said threshold is used for determining whether the received optical power of the optical receiver overloads; and
B2. when the current or voltage signal is larger than the set threshold, determining the received optical power of the optical receiver in the optical communication network overloads and outputting a corresponding control signal.

11. The method of claim 10, wherein said Step B2 comprises:
B21. recording the uplink time slot of the uplink optical signal corresponding to the current or voltage signal that leads to the received optical power overload of the optical receiver; and
B22. comparing the uplink time slot with the uplink time slot allocated by the central office terminal for each ONT or ONU to determine which ONT or ONU transmits the uplink signal that leads to the received optical power overload of the optical receiver.

12. The method of claim 8, wherein said Step B further comprises:
B3. setting the threshold of the current or voltage signal, wherein said threshold is used for determining whether an optical receiving module of the optical receiver in the optical communication network may be damaged; and
B4. when the current or voltage signal is larger than the set threshold, outputting a corresponding control signal.

13. The method of claim 12, wherein said Step B4 comprises:
configuring an optical switch in the optical communication network, said optical switch turning off the optical path leading to the optical receiver in the optical communication network upon receiving the outputted control signal so as to make the optical receiver unable to receive the uplink optical signal.

14. The method of claim 12, wherein said Step B4 comprises:
B41. recording the uplink slot of the uplink optical signal corresponding to the current or voltage signal that may damage the optical receiving module of the optical receiver;
B42. comparing the uplink time slot with the time slot allocated by a central office terminal for each ONT or ONU to determine which ONT or ONU transmits the uplink optical signal that may damage the optical receiving module of the optical receiver.

15. The method of claim 8, wherein said optical communication network comprises a Passive Optical Network (PON).

16. The method of claim 9, wherein said Step B comprises:
B1. setting the threshold of the current or voltage signal, wherein said threshold is used for determining whether the received optical power of the optical receiver overloads; and
B2. when the current or voltage signal is larger than the set threshold, determining the received optical power of the optical receiver in the optical communication network overloads and outputting a corresponding control signal.

17. The method of claim 16, wherein said Step B2 comprises:
B21. recording the uplink time slot of the uplink optical signal corresponding to the current or voltage signal that leads to the received optical power overload of the optical receiver; and
B22. comparing the uplink time slot with the uplink time slot allocated by the central office terminal for each ONT or ONU to determine which ONT or ONU transmits the uplink signal that leads to the received optical power overload of the optical receiver.

18. The method of claim 9, wherein said Step B further comprises:
B3. setting the threshold of the current or voltage signal, wherein said threshold is used for determining whether an optical receiving module of the optical receiver in the optical communication network may be damaged; and
B4. when the current or voltage signal is larger than the set threshold, outputting a corresponding control signal.

19. The method of claim 18, wherein said Step B4 comprises:
configuring an optical switch in the optical communication network, said optical switch turning off the optical path leading to the optical receiver in the optical communication network upon receiving the outputted control signal so as to make the optical receiver unable to receive the uplink optical signal.

20. The method of claim 18, wherein said Step B4 comprises:
B41. recording the uplink slot of the uplink optical signal corresponding to the current or voltage signal that may damage the optical receiving module of the optical receiver;
B42. comparing the uplink time slot with the time slot allocated by a central office terminal for each ONT or ONU to determine which ONT or ONU transmits the uplink optical signal that may damage the optical receiving module of the optical receiver.
